(19) United States
(12) Patent Application Publication
(10) Pub. No.: US 2024/0004797 A1
(43) Pub. Date: Jan. 4, 2024

(54) EFFICIENTLY MERGING NON-IDENTICAL PAGES IN KERNEL SAME-PAGE MERGING (KSM) FOR EFFICIENT AND IMPROVED MEMORY DEDUPLICATION AND SECURITY

(71) Applicant: Intel Corporation, Santa Clara, CA (US)

(72) Inventors: Reese KUPER, Austin, TX (US); Ren WANG, Portland, OR (US); Yifan YUAN, Sunnyvale, CA (US)

(21) Appl. No.: 18/369,090

(22) Filed: Sep. 15, 2023

(51) Int. Cl. G06F 12/0882; G06F 12/0842

(52) U.S. Cl. CPC G06F 12/0882; G06F 12/0842

(57) ABSTRACT

Methods and apparatus for efficiently merging non-identical pages in Kernel Same-page Merging (KSM) for efficient and improved memory deduplication and security. The methods and apparatus identify memory pages with similar data and selectively merge those pages based on criteria such as a threshold. Memory pages in memory for a computing platform are scanned to identify pages storing similar but not identical data. A delta record between the similar memory pages is created, and it is determined whether a size of the delta (i.e., amount of content that is different) is less than a threshold. If so, the delta record is used to merge the pages. In one aspect, operations for creating delta records and merging the content of memory pages using delta records is offloaded from a platform's CPU. Support for memory reads and memory writes are provided utilizing delta records, including merging and unmerging pages under applicable conditions.

### BACKGROUND INFORMATION

Multiple virtual memory regions may contain data equivalent or similar to memory associated with other memory regions. In instances of cloud computing and large-scale datacenters, the overall memory footprint resulting from identical data across all regions becomes significant and may result in less effective resource utilization. For instance, a cloud service provider may provide up to a certain number of virtual machines (VMs) to their clients as one of the main bottlenecks in offering more VMs is the total system memory available.

Different data deduplication techniques have developed in the past, and the most common implemented in the Linux kernel is called Kernel Same-page Merging, or KSM. This technique was introduced in late 2009 and is the primary deduplication feature that best solves this problem. KSM was originally developed for use with KVM (where it was known as Kernel Shared Memory), to fit more virtual machines into physical memory, by sharing the data common between them. But it can be useful to any application which generates many instances of the same data.

KSM offers some memory savings as it focuses on merging identical pages but it suffers a few disadvantages: 1) Current KSM misses opportunities of merging similar pages, which could be common in the cloud environment, 2) CPU resources (cycles and cache space) are often occupied (less available to applications) as a result of the KSM service, and 3) timing attacks present a security threat that can expose data found in separate memory regions.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a flow diagram illustrating an example of a KSM workflow;

FIG. 2 is a table listing functions and operations supported by a Data Streaming Accelerator (DSA), according to one embodiment;

FIG. 3 is a flow diagram illustrating an example of a KSM timing attack;

FIG. 4 is a flow diagram illustrating operations and logic used for merging memory pages having similar data, according to one embodiment;

FIG. 5 is a flow diagram illustrating operations performed in connection with a memory access request for a merged memory page, according to one embodiment;

FIG. 6 is a block diagram illustrating a DSA architecture, according to one embodiment;

FIG. 7 is a diagram illustrating a combined DSA software and hardware architecture, according to one embodiment;

FIG. 8 shows diagrams illustrating a software/hardware architecture and an associate example workflow, according to one embodiment;

FIG. 9a is a diagram illustrating a set of delta records, according to a first embodiment;

FIG. 9b is a diagram illustrating a set of delta records, according to a second embodiment;

FIG. 10 is a diagram illustrating an example of a batch work descriptor, according to one embodiment;

FIG. 11 is a diagram illustrating an example computing system that may be used to practice one or more embodiments disclosed herein;

FIG. 12 is a graph comparing throughput improvement when offloading memory page compare and delta creation operations from a CPU to a data streaming accelerator implemented in hardware; and

FIG. 13 is a graph comparing CPU utilization for memory page compare and delta creation operations implemented in software versus offloaded to a data streaming accelerator implemented in hardware.

### DETAILED DESCRIPTION

Embodiments of methods and apparatus for efficiently merging non-identical pages in Kernel Same-page Merging (KSM) for efficient and improved memory deduplication and security are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

The KSM algorithm considers pages that are identical to one another as possible merging opportunities due to the ease of remapping the data. In this disclosure, we propose 1) an efficient use of delta record data structure to reach higher levels of memory deduplication by merging similar pages, along with 2) offloading the record creation and application to Intel® Data Streaming Accelerator (DSA) to attain high throughput and cache pollution mitigation. The side benefit of delaying the process to unmerge merged pages via Copy-on-Writes helps in reducing the security threat posed by timing attacks to bring a safer, more impactful memory deduplication process to large-scale systems.

Through delta records, similar pages can be merged, and the differences can be tracked through storing these records associated with the merged pages. Delta records bring greater memory deduplication opportunities in the front-end of KSM, while obfuscating the unmerging (Copy-on-Write) process in the backend of the algorithm along with retaining merged pages for longer. Using Intel® DSA for the delta record operations brings greater throughput to the memory-intensive subtasks and avoids negative effects like cache pollution.

As mentioned above, memory is a critical resource in datacenters and is one of the limiting factors in the number of VM services offered by cloud providers. Due to the importance of reducing memory usage in these platforms, memory deduplication techniques are vital. KSM serves to combine duplicated pages found in memory regions, reducing the overall space these regions consume.

Generally, KSM's workflow starts by selecting a page from a memory region. This page is compared to already merged pages and infrequently modified pages. If either is the same, the selected page is merged. Otherwise, a checksum is generated to see how frequently this page changes (a useful metric for determining a good candidate for merging), and another page is selected to continue the KSM process.

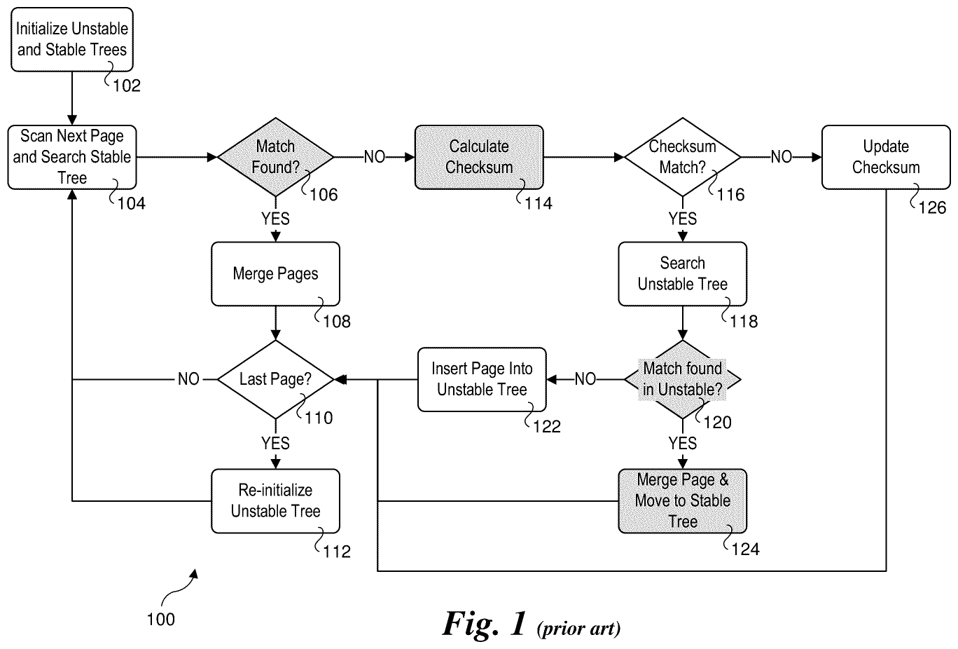

Specifically, an example of KSM's workflow is shown in a flow diagram 100 in FIG. 1, where the process starts by creating two tree data structures: a stable and unstable tree. The unstable tree is rebuilt after every scan and only contains pages that are not frequently changed—good candidates for merging. The stable tree holds pages that have already been merged and is persistent across scans.

The process of matching is done as follows (FPC=Finished Page Compare):
1) Load the next page within the memory region
2) Check current page with pages within the stable tree and merge if found (FPC)
3) Calculate the checksum hash of the current page
   a. If checksum does not match the page's stored value, update the value (FPC)
4) Check current page with pages with the unstable tree for a match
   a. If match was found, combine both pages and place merged pages in stable tree (FPC)
   b. If no match was found, insert the page into the unstable tree

The foregoing operations and logic are illustrated in flow diagram 100, where the flow begins in a block 102 in which the stable and unstable trees are initialized. In a block 104, a next page is scanned and the stable tree is searched. In a decision block 106 a determination is made to whether a match is found. If a match is found, the logic flows to a block 108 to merge the pages. A determination is then made in a decision block 110 to whether the page is a last page. If so, the logic flows to a block 112 in which the unstable tree is re-initialized. If the page is not the last page, the logic returns to block 104.

Returning to decision block 106, if a match is not found the logic proceeds to calculate a checksum in a block 114. A checksum match is then performed in a decision block 116. If there is a checksum match, the logic flows to a block 118 in which the unstable tree is searched. In a decision block 120 a determination is made to whether there is a match found in the unstable tree. If no match is found, a page is inserted into the unstable tree in a block 122 and the logic returns to decision block 110. If there is a match found, the logic flows to a block 124 in which the page is merged and moved to the stable tree. The logic then returns to decision block 110. If there is no checksum match in decision block 116, a checksum update is performed in a block 126, followed by the logic flowing to decision block 110.

Generally, all the operations and logic shown in FIG. 1 may be implemented in software (only), or a combination of software and hardware. In one embodiment, blocks shown with a white background are performed in software while blocks shown with a gray background are performed in hardware, such as using an accelerator, including but not limited to an Intel® DSA.

Delta Records and Similar Pages

Delta records are data elements that contain the differences between two regions of memory. An example would include a record of the differences found between two memory pages, where the source page is compared to a target page and the differences recorded with respect to the source page. Applying the delta record back to the common page (source page) results in the original target page.

With respect to KSM, similar pages can be merged by creating delta records for the page comparisons. This allows the similar merged page to retain the original data through the stored delta record and can be retried by applying the page's delta record to the merged content.

Intel® DSA Supported Operations

Intel® Data Streaming Accelerator is a high-performance data copy and transformation accelerator integrated into Intel® processors starting with 4th Generation Intel® Xeon® processors. It is targeted for optimizing streaming data movement and transformation operations common with applications for high-performance storage, networking, persistent memory, and various data processing applications. DSA supports several functions for KSM's DMA based operations. For instance, memory comparisons, delta record creation and merging, CRC checksum calculations, memory dual-casting, and additional operations are all enabled through this accelerator.

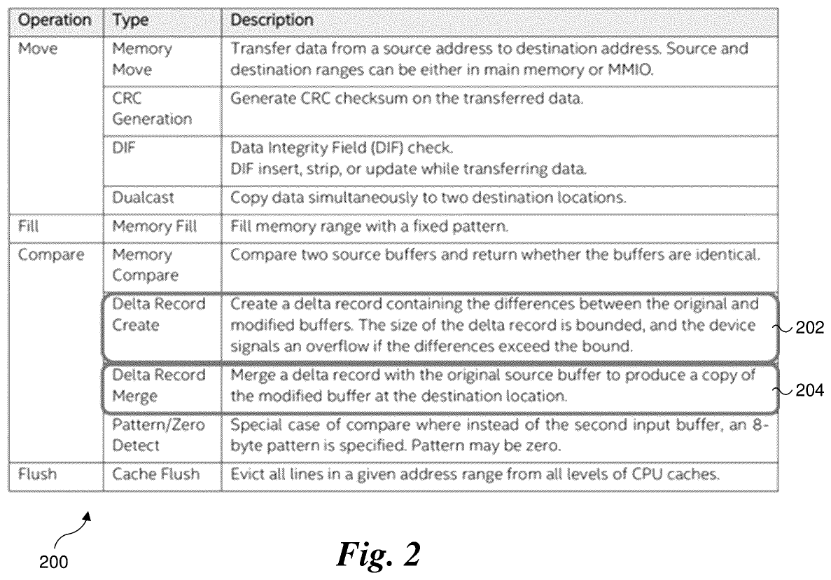

Some of the operations and functions supported by Intel® DSA are shown in Table 200 in FIG. 2. The functions include a Delta Record Create function 202, and a Delta Record Merge function 204. As illustrated, the Delta Record Create function creates a delta record containing the differences between the original and modified buffers, while the Delta Record Merge function merges a delta record with the original source buffer to produce a copy of the modified buffer at the destination location.

Intel® DSA is uniquely well-suited for managing these delta record tasks by accelerating their operation and offloading the work from the host processor. Delta records can be fully managed by software, but Intel® DSA removes the performance overhead introduced through the usage of delta records through higher throughput and the avoidance of cache pollution.

Reducing KSM Security Threats with Similar Page Merging

Most key concerns surrounding the use of KSM are in the form of timing attacks. This often starts with an attacker creating data identical to that already in the victim's memory space. KSM next merges the two identical pages, followed by the attacker updating the recently merged page. Since updating begins the CoW (Copy-on-Write) process, the time to manage this page update takes significantly longer due to copying and writing to the new page. This extra time is observed by the attacker, letting it be known that the page contains identical content to that of another page found within the victim's memory space.

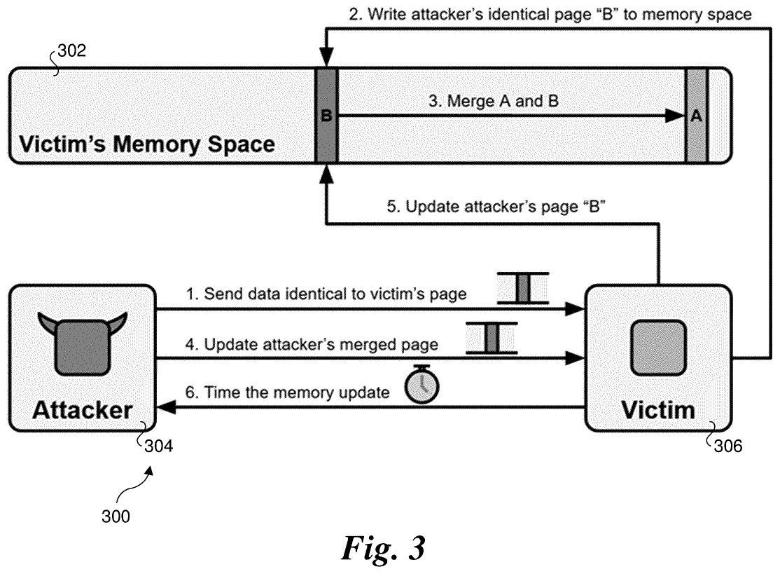

An example of this type of attack is shown in diagram 300 in FIG. 3. The high-level components are a victim's memory space 302, an attacker 304, and a victim application 306. First, at ‘1’ attacker 304 sends a request to victim application 306 with a page of data (page “B”) containing the same content as a page already present in victim's memory space 302 (page “A”). At ‘2’ victim 306 writes attackers identical page “B” to victim's memory space 302. At ‘3’ pages “A” and “B” are merged. Afterwards, the attacker waits for some time until the two pages “A” and “B” are merged by the operating system and point to the same physical address, as depicted at ‘3’. Next, at ‘4’ attacker 304 updates the attacker-controlled data in the merged page, which is updated by victim application 306 at ‘4’ and triggers a page-fault on the victim application. Depending on the response time of the victim, the attacker observes whether the page was deduplicated or not, as shown at ‘6’.

Using Delta Record for Optimizing KSM.

As mentioned above, this disclosure proposes the use of DSA's “delta record” operations for KSM to deduplicate similar pages. Unequal pages are commonly either entirely different, or only differ by a few bytes. Thus, In the case of slight differences, keeping track of these differences (i.e., deltas) can save further memory through merging nearly identical pages while tracking these small deltas.

The Delta Record Create and Merge operations of Intel® DSA can further lower the system's memory footprint through merging similar pages. In other words, the use of delta-record can extend same page merge to “similar” page merge. This is based on the observation that in cloud computing systems, only a small part in the 4 KB page is often modified, while the rest remains unchanged compared to the original version.

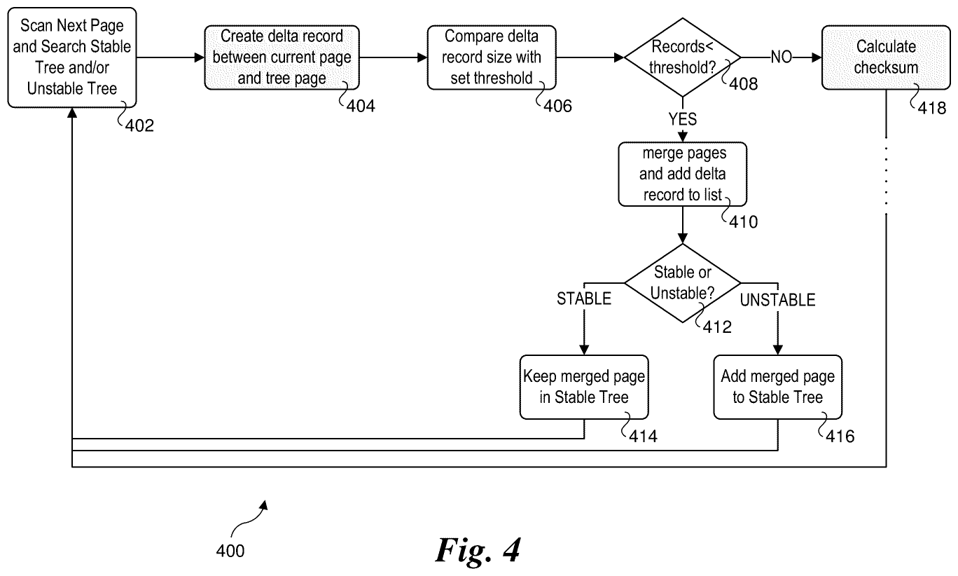

To make use of the delta records within KSM, the front-end flow would change by using delta record operations in place of page comparisons to determine how unique two pages are. If the page differences are below a certain threshold, the two pages are merged, and the differences are tracked via the created delta records. An example of this approach is illustrated in flow diagram 400 in FIG. 4, where blocks with a white background are implemented in software while blocks with a gray background are implemented in hardware (e.g., by a DSA or other accelerator). The merging of similar pages increases the memory deduplication opportunities and thus improves upon the primary purpose of KSM.

In a block 402 a next page (now current page) is scanned, and the stable tree and/or unstable tree is searched. In a block 404 a delta record is created between the current page and the page in the stable tree. In a block 406 the delta record size between the current page and tree page are compared with a set threshold. In a decision block 408 a determination is made to whether the differences between current page and tree page, as reflected by the delta record, is less than the threshold. If it is, the pages are merged and the delta record is added to the list in a block 410. As depicted by a decision block 412 and a block 414, if the tree (for which the page comparison is made) is the stable tree the merged page is kept in the stable tree and the flow returns to block 402 to evaluate the next page. If the tree (for which the page comparison is made) is the unstable tree, the merged page is added to the stable tree, as shown in a block 416, with the flow returning to block 402 to evaluate the next page. Returning to decision block 408, if the difference between the current page and tree page is greater than the threshold, a checksum is calculated for the current page in a block 418, and the flow returns to block 402.

Utilizing Delta Records to Retain Merged Pages for Longer

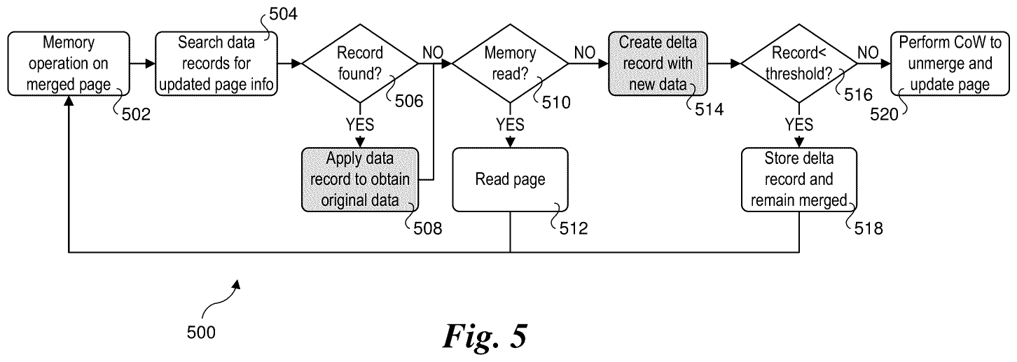

Under another aspect of some embodiments, the back end is modified to use delta records when merged pages are either read or written to. An example of this approach is shown in flow diagram 500 in FIG. 5, where blocks with a white background are implemented in software while blocks with a gray background are implemented in hardware (e.g., by a DSA or other accelerator). The back end is modified to use delta records when merged pages are either read or written to, shown in FIG. 5. When managing pages in this workflow, any existing delta records are applied to obtain the original data before servicing the memory requests. If a memory read occurs, the original page data can be returned after applying its associated delta record if one exists. A memory write checks if the memory request exceeds a threshold for the associated merged page. This threshold may be 1) size-based where the delta record size is below a certain size, 2) time-based where the page remains merged if updated within a certain time since the last update, or 3) frequency-based where the page unmerges after a certain number of updates made. A combination of these threshold types can be used for a more resilient design. In either case, the delta record is updated if the update is under the threshold, otherwise the copy-on-write (CoW) unmerges the page.

Referring to flow diagram 500, the flow begins in a block 502 in which a memory operation on a merged page is performed. Next, in a block 504, delta records are searched for updated page information. In a decision block 506 a determination is made to whether a record is found. If so, the delta record is applied in a block 508 to obtain the original data.

Following block 508 or decision block 506 if no record is found, the flow proceeds to a decision block 510 to determine whether the memory access is a memory read. If it is, the page is read in a block 512 and the flow returns to block 502. If the memory access is a memory write, the flow proceeds to a block 514 in which a delta record is created with new data.

Next, a determination is made in a decision block 516 to whether the delta records is less than a threshold. As discussed above, this threshold may be 1) size-based where the delta record size is below a certain size, 2) time-based where the page remains merged if updated within a certain time since the last update, or 3) frequency-based where the page unmerges after a certain number of updates made, or a combination of 1), 2) and/or 3) may be implemented. If the delta record is less than the threshold(s), the delta record is stored and the merged page remains merged, as depicted in a block 518, with the flow returning to block 502. If the delta record is not less than the threshold(s), a copy-on-write (CoW) is performed in a block 520 to unmerge the page and update the unmerged page.

Since many security threats targeting KSM involve carefully timing the CoW process, the attackers must have precise knowledge of both the contents and times of when the merged pages become separated. With the use of delta records, these pages can remain merged until some unknown threshold is reached—obfuscating when the unmerge takes place. Additionally, the contents of the unmerged process cannot be precisely known given the tracking of the content's delta records. These two added benefits to KSM reduce the primary security threat targeting memory deduplication.

Exemplary DSA Architecture

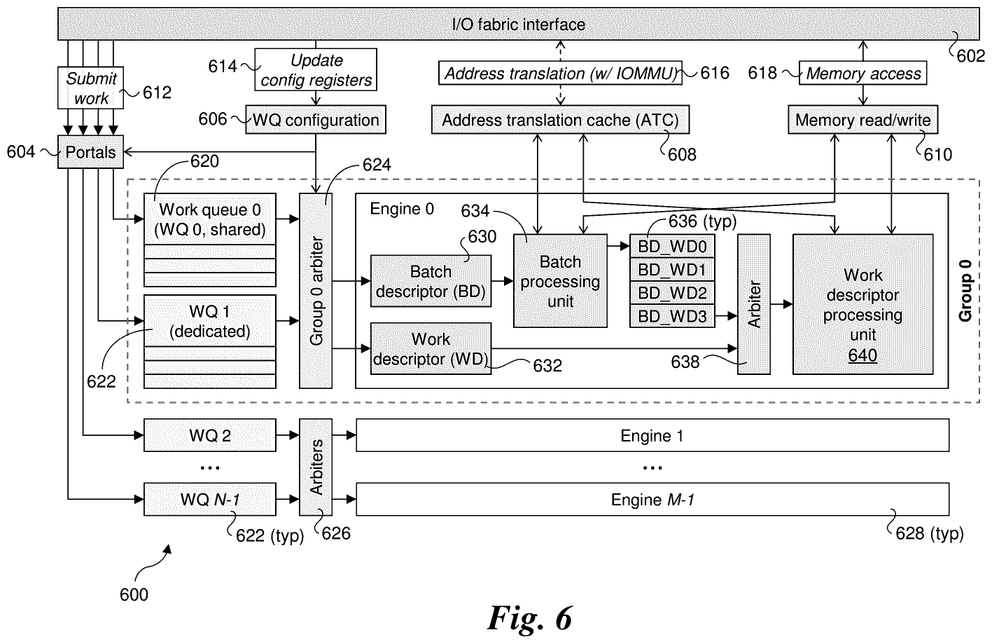

FIG. 6 shows a block diagram illustrating a DSA architecture 600, according to one embodiment. DSA architecture 600 includes an input/output (I/O) fabric interface 602 that is operatively coupled cores in the CPU (central processing unit, not shown) of a System on Chip (SoC) on which the CPU and DSA is implemented. I/O fabric interface 602 is connected to memory-mapped portals 604, Work Queue (WQ) configuration 606, address translation cache 608 and memory read write block 610. Software, executing on cores in the CPU, is enabled to perform various functions, including submit work 612 to portals 604, update configuration registers 614, perform address translation 616, and perform memory access 618. Address translation 616 is facilitated, in part, through use of an Input-Output Memory Management Unit (IOMMU).

Work Descriptors (WDs) describing work to be performed are submitted to memory-mapped portals 604, which are used to place WDs in WQs. There are multiple groups of associated components, each having a configuration similar to Group 0. Work queue 620, labeled WQ 0, is a work queue that is shared across groups. Meanwhile, there is a dedicated WQ 622 for each group. Each group includes a group arbiter, as depicted by group 0 arbiter 624 for Group 0 and arbiter 626.

Each group also includes an engine 628 (also referred to as a processing engine or PE), which performs the work described by the WDs and batch descriptors. As depicted by Engine 0 for Group 0, an engine 628 includes a batch descriptor block 630, a work descriptor block 632 a batch processing unit 634 coupled to BD_WDs 636, an arbiter 638, and a work descriptor processing unit 640. A batch descriptor is a type of work descriptor that enables a batch of work to do. For example, a batch descriptor could request and engine to compare the content of a page with all other pages in a given memory range. As another example, a batch descriptor may instruct the engine to identify all delta records having a size less than a threshold.

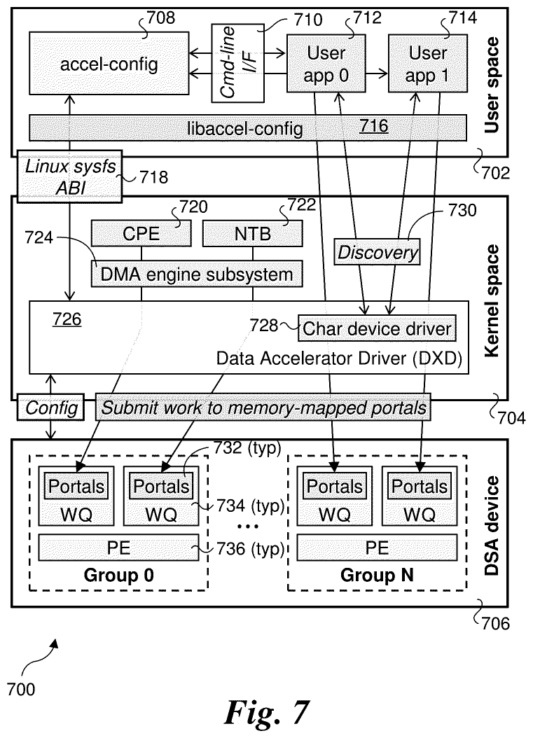

FIG. 7 shows a combined DSA software and hardware architecture 700. The top-level components include user space 702, kernel space 704, and a DSA device 706. User space 702 and kernel space 704 are in memory and comprise software components, while DSA device 706 comprises a hardware component, such as embedded logic on an SoC. The software components are executed on one or more cores in the CPU of the SoC.

The user space components include an accelerator configuration block 708, a command line interface 710, user applications 712 and 714, and an accelerator configuration library 716. The kernel space components include Common Platform Enumeration (CPE) 720, Non-Transparent Bridge (NTB) 722, a DMA engine subsystem 724, and a data accelerator driver (DXD) 726 having a Char device driver 728. A Linux sysfs application binary interface (ABI) 718 provides an interface between accelerator configuration block 708 and DXD 726. Char device driver 728 supports discovery 730.

DSA device 706 depicts a simplified version of DSA architecture 600. As above, the is a group of components for each of multiple groups, depicted as Group 0 and Group N. The illustrated components include memory-mapped portals 732, WQs 734, and PEs 736. DXD driver 726 is enabled to configure various components in DSA device 706. As further shown, user applications 712 and 714 are enabled to submit work to memory-mapped portals 732.

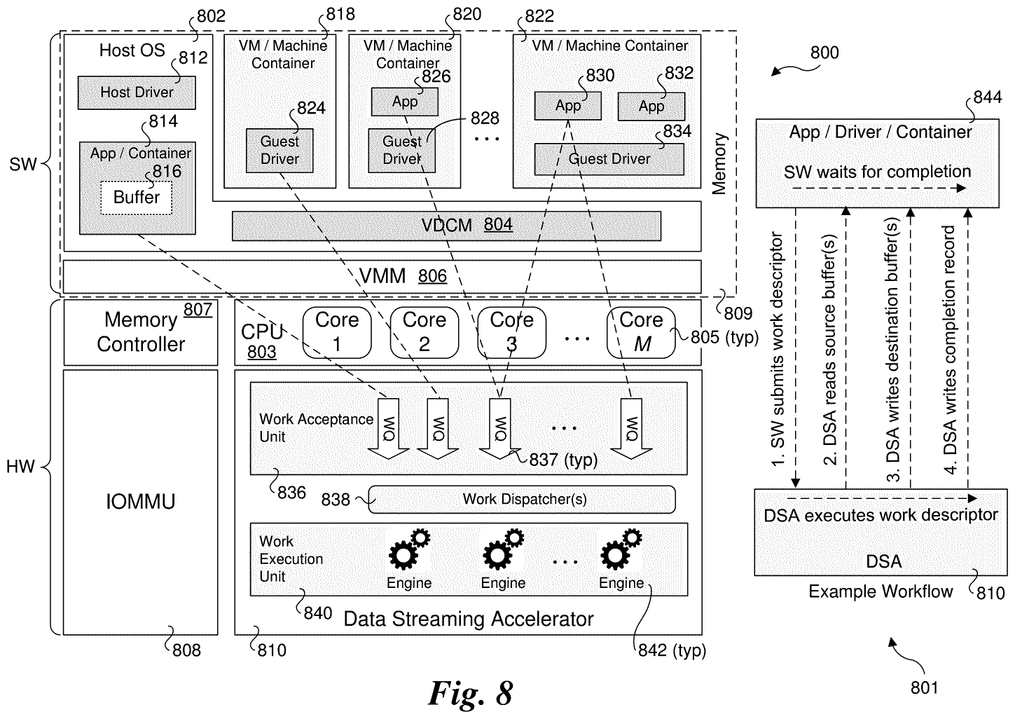

FIG. 8 shows a software/hardware architecture 800 and an associate example workflow 801. The top-level software components include a host OS 802, a VCDM 804, and a Virtual Machine Manager (VMM) 806. The top-level hardware components include a CPU 803 with M cores 805, a memory controller 807, an IOMMU 808 and a data streaming accelerator 810. In one embodiment, the hardware components are integrated on an SoC that would include additional circuitry that is not shown for clarity, such as a multi-level cache architecture, various interconnects, and I/O interfaces, as are known in the art. Memory controller 807 provides an interface to memory 809 via one or more memory channels. The software components are loaded into memory and executed on one or more of CPU cores 805. IOMMU may be integrated in memory controller 807 or comprise a separate logic block that interfaces with memory controller 807.

Host OS includes a host driver 812 and an application or container 814 with a buffer 816. The software environment would include one or more VMs or containers, as depicted by VM/Container 818, 820, and 822. VM/Container 818 includes a guest driver 824. VM/Container 820 includes an application 826 and a guest driver 828. VM/Container 822 includes applications 830 and 832 and a guest driver 834.

Data streaming accelerator 810 includes a work acceptance unit 836 with multiple WQs 837, one or more work dispatchers 838, and a work execution unit 840 having multiple engines 842. Work dispatchers 838 work in a similar manner to arbiters 624 and 626 in DSA architecture 600 discussed above, e.g., they are configured to dispatch work to the engines 842 in work execution unit 840.

Example workflow 801 shows communication between an App/Driver/Container 844 and DSA 810. During a first operation, software submits a work descriptor to DSA 810. As depicted in FIG. 8, various software entities can submit work descriptors, including an App/Container, guest drivers, and applications. The work descriptors are submitted via portals (not shown in FIG. 8) and queued in WQs 837, as before.

During the second operation, the DSA reads source buffer(s) identified in the work descriptor. The DSA performs an applicable operation (such as delta record merge) and write to one or more destination buffers during a third operation. The DSA then writes a completion records, as depicted for a fourth operation.

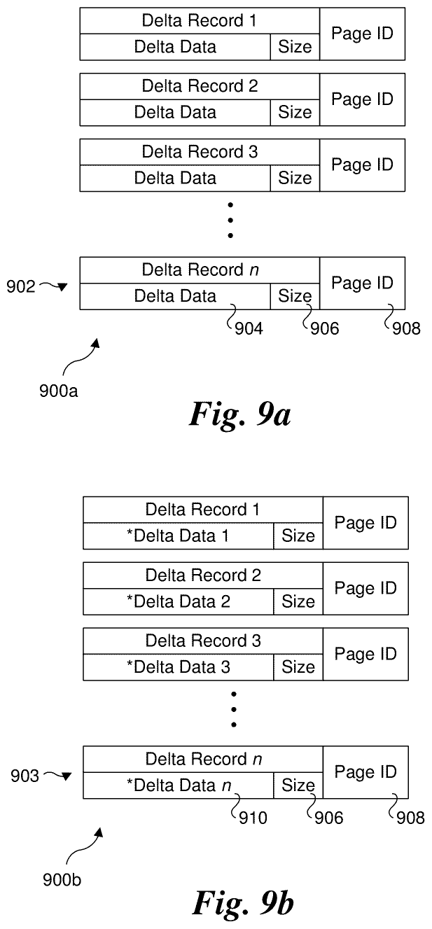

Software maintains various data structures to support the software functionality described herein. Those data structures include one or more sets of delta records that store delta record data generated by the DSA. Under the example shown in FIG. 9a, delta record data structure 900a includes a plurality of data records 902 stored in an array or list. Each delta record 902 includes delta data 904, a size field 906, and a page ID 908. The delta data represents the difference between two pages as generated by the DSA, which may vary in size, which is stored in size field 906. Page ID 908 provides an identifier for the page associated with the delta record, such as a memory address for the page.

FIG. 9b shows an alternative example of delta record data structure 900b. In this example, each delta record 903 includes a delta data pointer 910, a size field 906, and a page ID 908. Under this embodiment, the delta data is stored in memory separate from delta records 903, where delta data pointer 910 is used to locate where the delta data for the delta record is stored (e.g., address of the start of the delta data in memory). An advantage of delta record data structure 900b is that the size of each delta record is the same, which supports slightly faster searching for delta records having a size below a threshold. For instance, sequential size fields 906 will be located at a fixed offset.

As described above, software may submit work descriptors to the DSA/accelerator. A work descriptor operates as an instruction telling the DSA/accelerator what work to do. Work descriptors may be singular or batched. For example, a single work descriptor may identify two buffers to compare (where the buffers are memory address for respective pages). By comparison, a batch work descriptor may identify multiple pages to compare.

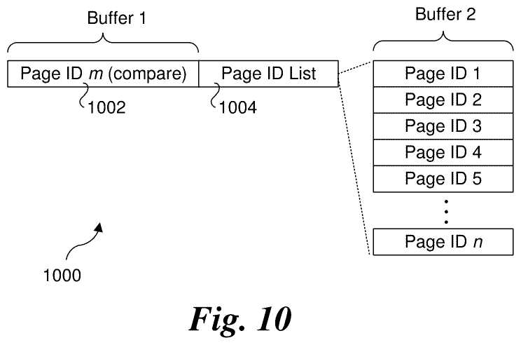

FIG. 10 shows an example of a batch WD 1000, according to one embodiment. The batch WD includes a first page ID 1002 corresponding to a first buffer that is to be compared with multiple pages in a page ID list 1004. Each page ID in page ID list 1004 identifies the location of a second buffer. The DSA/accelerator will then perform a compare operation, such as creating a delta record, for the page identified by first page ID 1002 with each of the pages identified by the page IDs in page ID list 1004. Depending on the implementation, a batch WD may further instruct the DSA/accelerator where in memory to put the results for each compare operation, or the architecture may be structured such that work queue result structures and work completion structures are used, as is known in the art. Such structures may be implemented as circular buffers or the like using head and tail pointers, for example. Similar structures may be used for individual WDs and batch WDs.

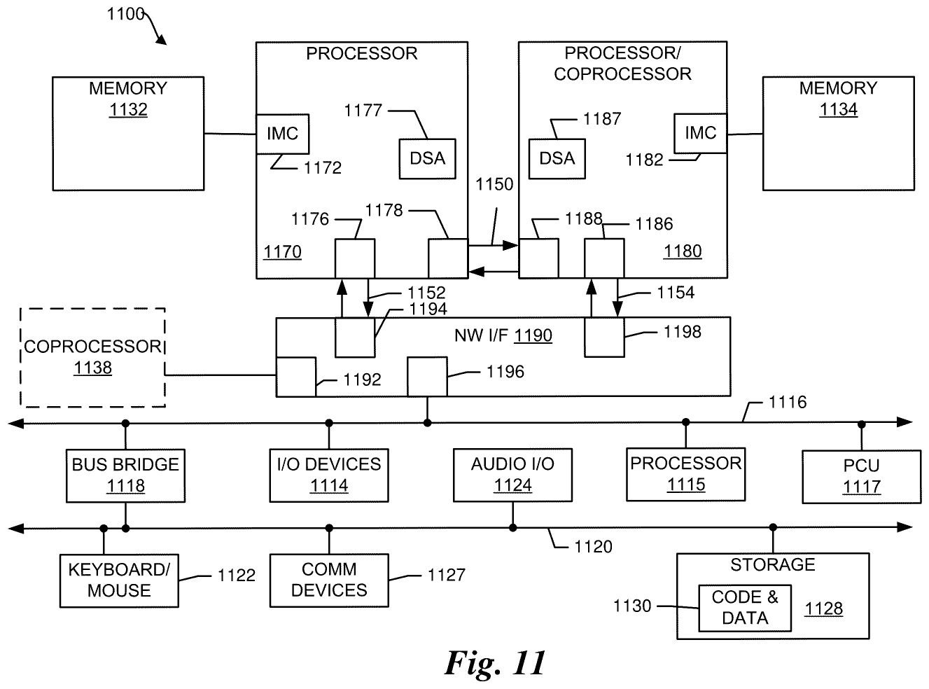

FIG. 11 illustrates an example computing system. System 1100 is an interfaced system and includes a plurality of processors or cores including a first processor 1170 and a second processor 1180 coupled via an interface 1150 such as a point-to-point (P-P) interconnect, a fabric, and/or bus. In some examples, the first processor 1170 and the second processor 1180 are homogeneous. In some examples, first processor 1170 and the second processor 1180 are heterogenous. Though the example system 1100 is shown to have two processors, the system may have three or more processors, or may be a single processor system. In some examples, the computing system is a system on a chip (SoC).

Processors 1170 and 1180 are shown including integrated memory controller (IMC) circuitry 1172 and 1182, respectively and DSAs 1177 and 1187, respectively. Processor 1170 also includes interface circuits 1176 and 1178; similarly, second processor 1180 includes interface circuits 1186 and 1188. Processors 1170, 1180 may exchange information via the interface 1150 using interface circuits 1178, 1188. IMCs 1172 and 1182 couple the processors 1170, 1180 to respective memories, namely a memory 1132 and a memory 1134, which may be portions of main memory locally attached to the respective processors.

DSAs 1177 and 1187 comprise circuitry and logic configured to implement the various DSA operations and functionality described herein. Generally, DSAs 1177 and 1187 are accelerators that may employ circuitry/logic may comprising one or more of Field Programmable Gate Array (FPGA(s)) or other programmable hardware logic, Application Specific Integrated Circuits (ASICs), one or more embedded processing elements running embedded software, firmware, or other forms of embedded logic. Moreover, the use of Intel® DSAs herein is exemplary and non-limiting, as other accelerators configured to support similar functionality may be used.

Processors 1170, 1180 may each exchange information with a network interface (NW I/F) 1190 via individual interfaces 1152, 1154 using interface circuits 1176, 1194, 1186, 1198. The network interface 1190 (e.g., one or more of an interconnect, bus, and/or fabric, and in some examples is a chipset) may optionally exchange information with a coprocessor 1138 via an interface circuit 1192. In some examples, the coprocessor 1138 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1170, 1180 or outside of both processors, yet connected with the processors via an interface such as P-P interconnect, such that either or both processors' local cache information may be stored in the shared cache if a processor is placed into a low power mode.

Network interface 1190 may be coupled to a first interface 1116 via interface circuit 1196. In some examples, first interface 1116 may be an interface such as a Peripheral Component Interconnect (PCI) interconnect, a PCI Express interconnect or another I/O interconnect. In some examples, first interface 1116 is coupled to a power control unit (PCU) 1117, which may include circuitry, software, and/or firmware to perform power management operations with regard to the processors 1170, 1180 and/or coprocessor 1138. PCU 1117 provides control information to a voltage regulator (not shown) to cause the voltage regulator to generate the appropriate regulated voltage. PCU 1117 also provides control information to control the operating voltage generated. In various examples, PCU 1117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1117 is illustrated as being present as logic separate from the processor 1170 and/or processor 1180. In other cases, PCU 1117 may execute on a given one or more of cores (not shown) of processor 1170 or 1180. In some cases, PCU 1117 may be implemented as a microcontroller (dedicated or general-purpose) or other control logic configured to execute its own dedicated power management code, sometimes referred to as P-code. In yet other examples, power management operations to be performed by PCU 1117 may be implemented externally to a processor, such as by way of a separate power management integrated circuit (PMIC) or another component external to the processor. In yet other examples, power management operations to be performed by PCU 1117 may be implemented within BIOS or other system software.

Various I/O devices 1114 may be coupled to first interface 1116, along with a bus bridge 1118 which couples first interface 1116 to a second interface 1120. In some examples, one or more additional processor(s) 1115, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1116. In some examples, second interface 1120 may be a low pin count (LPC) interface. Various devices may be coupled to second interface 1120 including, for example, a keyboard and/or mouse 1122, communication devices 1127 and storage circuitry 1128. Storage circuitry 1128 may be one or more non-transitory machine-readable storage media, such as a disk drive, Flash drive, SSD, or other mass storage device which may include instructions/code and data 1130. Further, an audio I/O 1124 may be coupled to second interface 1120. Note that other architectures than the point-to-point architecture described above are possible. For example, instead of the point-to-point architecture, a system such as system 1100 may implement a multi-drop interface or other such architecture.

The benefits of the proposal are 4-fold: 1) Improve the memory saving by merging not only same pages, but similar pages, 2) Significantly reduce the CPU cache occupancy by KSM operations to enable applications to take advantage of more cache capacities, 3) Potential throughput improvement due to more efficient operations by DSA, and 4) reduce the risk of timing attacks by delaying the unmerge process.

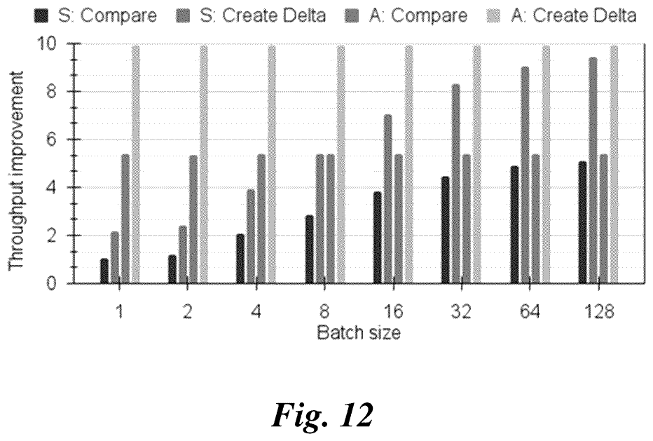

Based on preliminary performance results of using an accelerator like Intel® DSA for offloading related operations, performance would be improved once implemented into KSM. For all relevant operations, throughput improvements are seen right away for all operations with only a synchronous 4 KB memory copy through Intel® DSA being nearly equivalent to its CPU software counterpart in FIG. 12. I/O fabric interface 602 is coupled to a submit work block 612,

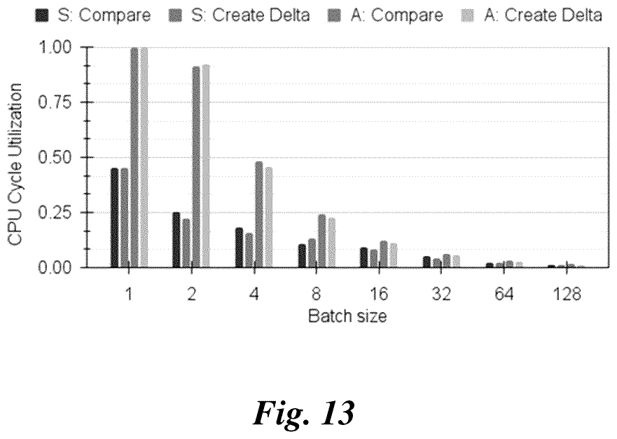

FIG. 13 shows the CPU cycles spent running the relevant operations on Intel® DSA. When the operations are serviced on Intel® DSA, the offloading core is free to run other processes while waiting for the completion of the offloaded work. Complete asynchronous usage of Intel® DSA uses more cycles for offloading more descriptors, but still opens CPU time once descriptors are batched. Realistic use cases of Intel® DSA can see moderate asynchronicity and batching to exhibit both high throughput and low CPU cycle utilization.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as ‘m’, ‘n’, ‘M’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by a processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, FPGAs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for performing Kernel Same-page Merging (KSM), comprising:
scanning a plurality of memory pages in memory for a computing platform to identify first and second memory pages storing similar but not identical data;
creating a delta record between the first memory page and second memory page;
determining the delta record has a size that is less than a first threshold; and
using the delta record to merge the first memory page with the second memory page.

2. The method of claim 1, further comprising:
maintaining a stable tree comprising a data structure identifying memory pages that have already been merged and are consistent across scans;
scanning a next page in memory that is not in the stable tree and searching the stable tree for a non-matching similar page, the next page becoming a current page;
creating a delta record between the current page and a non-matching similar page in the stable tree; and
determining whether the delta record has a size that is less than the first threshold.

3. The method of claim 1, further comprising:
receiving a memory access request on a merged page;
searching delta records for updated page information for the merged page; and
when there is a delta record that is found, applying the delta record to the merged page to obtain updated data for the merged page.

4. The method of claim 3, wherein the memory access request is a memory write on the merged page, further comprising:
creating a new delta record with new data associated with the memory write;
determining whether the new delta record is less than a second threshold; and
when the new delta record is less than the second threshold, storing the new delta record and keeping the merged page merged.

5. The method of claim 4, wherein the new delta record includes a size of the new delta and the second threshold is a size.

6. The method of claim 3, wherein the new delta record includes a time when the merged page was last updated, and wherein the second threshold is a time threshold under which the merged page remains merged if the last updated time is less than the time threshold.

7. The method of claim 3, wherein the new delta record includes a number of updates since the merged page was merged, and wherein the second threshold is an update count threshold under which the merged page is unmerged when the number of updates exceeds the update count threshold, further comprising performing a copy-on-write to update the unmerged page.

8. The method of claim 1, wherein the platform includes a System on a Chip (SoC) having a central processing unit (CPU) on which instructions comprising a Linux operating system and one or more application are executed, and wherein the operations of creating the delta record and using the delta record to merge the first memory page with the second memory page is performed by embedded logic on the SoC that is separate from the CPU.

9. The method of claim 8, wherein the embedded logic comprises a data streaming accelerator.

10. A computing platform comprising:
a System on a Chip (SoC) having a multi-core central processing unit (CPU) with a plurality of processor cores;
memory, coupled to the SoC, at least a portion of which is logically partitioned into a plurality of pages;
software instructions, configured to be executed on one or more processor cores of the multi-core CPU,
wherein the computing platform is enabled to perform operations to effect Kernel Same-page Merging (KSM), including,
scan memory pages in the at least a portion of memory to identify first and second memory pages storing similar but not identical data;
create a delta record between a first memory page and a second memory page;
determine the delta record has a size that is less than a first threshold; and
utilize the delta record to merge the first memory page with the second memory page.

11. The computing platform of claim 10, further enabled to:
maintain a stable tree comprising a data structure identifying memory pages that have already been merged and are consistent across scans;
scan a next page in memory that is not in the stable tree and search the stable tree for a non-matching similar page, the next page becoming a current page;
create a delta record between the current page and a non-matching similar page in the stable tree; and
determine whether the delta record has a size that is less than the first threshold.

12. The computing platform of claim 10, further enabled to:
receive a memory access request on a merged page;
search delta records for updated page information for the merged page; and
when there is a delta record that is found, apply the delta record to the merged page to obtain updated data for the merged page.

13. The computing platform of claim 12, wherein the memory access request is a memory write on the merged page, further enabled to:
create a new delta record with new data associated with the memory write;
determine whether the new delta record is less than a second threshold; and
when the new delta record is less than the second threshold, store the new data record and keep the merged page merged.

14. The computing platform of claim 12, wherein the new delta record includes a size of the new data and the second threshold is a size.

15. The computing platform of claim 12, wherein the new delta record includes a time when the merged page was last updated, and wherein the second threshold is a time threshold under which the merged page remains merged if the last updated time is less than the time threshold.

16. The computing platform of claim 12, wherein the new delta record includes a number of updates since the merged page was merged, and wherein the second threshold is an update count threshold under which the merged page is unmerged when the number of updates exceeds the update count threshold, further comprising performing a copy-on-write to update the unmerged page.

17. A non-transitory machine-readable medium have instructions stored thereon configured to be executed on central processor unit (CPU) of a System on a Chip (Soc) in a computing platform, the SoC including an accelerator enabled to create delta records between first and second buffers and produce merged buffers using delta records, wherein execution of the instructions enables the computing platform to:
maintaining information identifying a set of merged memory pages;
for a memory write to a merged memory page having write data,
apply the write data to an original buffer associated with the merged memory page to obtain a modified buffer;
instruct the accelerator to create a delta record between the original buffer and the modified buffer, the accelerator returning the delta record including a size;
determine whether the delta record has a size that is less than a threshold; and
when the size of the delta record is less than the threshold, instruct the accelerator to use the delta record to merge the modified buffer with the original buffer to update the merged memory page,
wherein the merged memory page is kept merged.

18. The non-transitory machine-readable medium of claim 17, wherein execution of the instructions further enables the computing platform to:
when the delta record size is greater is not less than the threshold,
perform a copy-on-write to unmerge the merged page to create an unmerged page and update the unmerged page.

19. The non-transitory machine-readable medium of claim 17, wherein execution of the instructions further enables the computing platform to:
maintain a stable tree comprising a data structure identifying memory pages that have already been merged and are consistent across scans;
scan a next page in memory that is not in the stable tree and search the stable tree for a non-matching similar page, the next page becoming a current page;
instruct the accelerator to create a delta record between the current page and a non-matching similar page in the stable tree; and
determine whether the delta record has a size that is less than the threshold.

20. The non-transitory machine-readable medium of claim 17, wherein execution of the instructions further enables the computing platform to:
receive a memory access request on a merged page;
search delta records for updated page information for the merged page; and
when there is a delta record that is found, instruct the accelerator to apply the delta record to the merged page to obtain updated data for the merged page.
